(19) United States
(12) Patent Application Publication
(10) Pub. No.: US 2007/0168296 A1
(43) Pub. Date: Jul. 19, 2007

(54) Method of providing a mobile non-secular media service

(76) Inventors: Bonnie Sue Lelak, Canton, GA (US); David Daniel Lelak, Canton, GA (US)

Correspondence Address: STEVEN L. SCHMID, 1824 HICKORY TRACE DRIVE, FLEMING ISLAND, FL, 32003, US

(21) Appl. No.: 11/332,831

(22) Filed: Jan. 13, 2006

(51) Int. Cl. G06Q 99/00

(52) U.S. Cl. 705/64

(57) ABSTRACT

Disclosed is a method for providing a mobile, non-secular media delivery service. The service provides both audio and audiovisual materials of a religious nature to individuals for a set period of time for a fee. The service is mobile and meets the customer at a convenient location. The method further provides a wide selection of audio teaching CDs, cassette tapes and videos that may include sermons, presentations by various speakers, books and movies.

### TECHNICAL FIELD

The present invention is directed to a mobile media service and in greater detail the invention is directed to a mobile service for providing non-secular media to a religious audience.

### BACKGROUND OF THE INVENTION

Over the years, the delivery of media has changed radically such that today most U.S. households get at least 50 channels of television programming and have a VCR and/or a DVD player. The way in which pre-recorded audio and audiovisual programming is accessed by the consumer has also changed rapidly by providing the consumer with a wide range of options, including fixed store locations and mail services. However, even with these options certain segments of the population have been underserved in the pre-recorded audio and audiovisual media market.

VCRs have been in homes for years along with fixed video rental stores being located almost everywhere. Additionally, as more and more households purchase DVD players and other advanced media products, video rental stores have had to adjust their inventory to accommodate this changing demand for more advanced media, such as the digital versatile disc (“DVD”). However, while such rental stores include a variety of media, e.g., feature length film DVDs, audio CDs, and VHS videos they have neglected content diversification such as providing religious entertainment and teaching.

For example, Blockbuster, Hollywood Video, and Movie Gallery operate the traditional video rental store but fail to provide any religious audio content and very little religious audiovisual content. In such fixed store models a consumer completes a membership form to become a member of the store, which allows the consumer to rent movies from the available inventory for a rental fee per item. Generally, the rental fee is based on the length of time, and the consumer has until the item must be returned to the store. If the item is not returned to the store on time, the consumer is assessed an additional fee/fine for the additional length of time the consumer holds onto the item. Generally, the item is required to be returned to the same store.

NetFlix is a mail-based method of DVD movie rental. The consumer becomes a member by paying a monthly subscription fee, which allows the consumer to select as many DVDs each month for viewing as long as the consumer has no more than three DVDs at anyone time. The consumer selects DVDs at the NetFlix web site. The DVD is mailed via first-class mail to the consumer, and the consumer returns the DVD to NetFlix using a prepaid mailer at a convenient time—there is no deadline for returning the DVD. After NetFlix receives the returned DVD, NetFlix sends out the next DVD on the consumer's selection list, which is stored on the NetFlix Internet server. NetFlix also fails to provide religious audio content and very little religious audiovisual content.

The above mentioned media delivery services fail to bring media content directly to a targeted audience and each fails to provide both audio and audiovisual materials of a religious nature. Fixed media outlets such as Blockbuster require a customer to commute to and from the fixed storefront to rent the desired media. A mail-based service such as NetFlix requires a third party to deliver content to a customer.

Within the religious community there is need for providing media that is directed to the desires of the religious audience. Neither of the above described media delivery models provides the desired audio and audiovisual media content requested by the religious community. What is needed is a media outlet that provides both audio and audiovisual material of a religious nature to a religious audience at a convenient location.

While religious book stores or retailers may sell or rent some audio and audiovisual material the number of stores and the product selection is very limited. Additionally, like the Blockbuster stores, religious retailers have fixed locations and are unable to meet the customer where religious customers congregate. Thus, what is needed is a convenient method for providing religious media materials to a targeted religious audience.

### SUMMARY

The present invention is directed to a method for providing a mobile, non-secular media delivery service. Typically, the service provides both audio and audiovisual materials of a religious nature to individuals for a set period of time for a fee. The service is mobile and meets the customer at a convenient location. The method further provides a wide selection of audio teaching CD and cassette tapes. Such teaching materials may include sermons, presentations by various speakers and books. Additionally, videos are provided in the form of DVDs or video cassettes of religious movies, presentations, or speakers.

In greater detail, the method includes a system for providing mobile non-secular audio and audiovisual media materials by providing a mobile retail platform including various non-secular audio and audiovisual media materials contained within the mobile platform. The method further includes delivering the mobile retail platform to various non-secular functions and then renting the audio and audiovisual media materials to customers.

The mobile method includes a tracking database for cataloging a selected customer's preferences and providing suggestions to the selected customer based on the collected preferences. The mobile retail platform may be an automobile, truck, or van modified to hold a collection of media material. The mobile platform may visit such non-secular functions as religious or church services and the platform may follow a predetermined route to aid in the efficient renting and returning of materials.

In a further embodiment the method of providing mobile non-secular teaching materials to participants at a religious function includes providing a mobile retail platform having a collection of audio and audiovisual teaching materials exclusively of a non-secular nature and delivering the mobile retail platform to a religious event having various attendees. Once at the event, the audio and audiovisual materials may be rented to the various attendees for a fee for a fixed period of time. It is further contemplated that the present method may be franchised out to others for use.

An additional embodiment includes providing mobile non-secular teaching materials to participants at a religious function comprising a mobile retail platform including a motor vehicle with a collection of audio and audiovisual teaching materials exclusively of a non-secular nature for a religious audience. The method includes the delivery of the mobile retail platform to a church service having various attendees and then renting the audio and audiovisual materials to the various attendees for a fee for a fixed period of time. The method further includes a fee paid to organizers of the religious event, wherein the fee is part of a fund raising activity for the organizers of the religious event and is based in part on the fees collected from the rental of the materials.

### DRAWINGS

The above mentioned features of the invention and the manner of attaining them will become apparent, and the invention itself will be best understood by reference to the following description of the embodiments of the invention in conjunction with the accompanying drawings wherein:

FIG. 1 is a block diagram illustrating the present method for providing a mobile, non-secular media delivery service including a mobile platform;

FIG. 2 is a flow chart of the steps performed in the rental step and the tracking of the customers preferences; and

FIG. 3 is a further flow chart illustrating the fund raising aspect of the method for providing a mobile, non-secular media delivery service.

### DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items.

The present invention is directed to a method for providing a mobile, non-secular media delivery service having both audio and audiovisual materials of a religious nature for loan to individuals for a set period of time for a fee. The service is mobile and is designed to meet the customer at a convenient location for both delivery of the product and pickup of the same. The method provides a wide selection of audio teaching CD and cassette tapes along with videos of religious movies, presentations, and/or speakers.

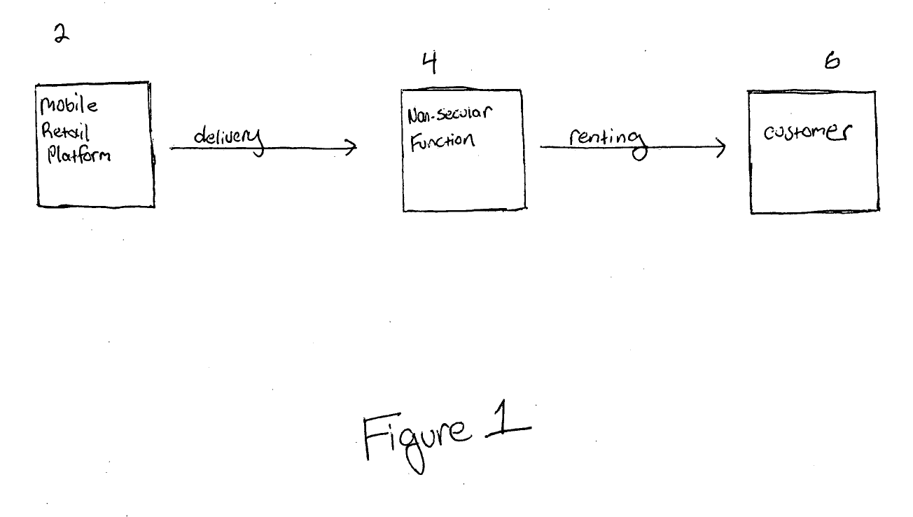

Referring now in greater detail to the drawings in which like numerals indicate like parts throughout the several views, FIGS. 1-3 depict the method for providing a mobile, non-secular media delivery service in various embodiments of the present invention

As illustrated in FIG. 1, the method includes a system for providing mobile non-secular audio and audiovisual media materials by providing a mobile retail platform 2. The mobile platform 2 may be any platform capable of carrying and containing various non-secular audio and audiovisual media materials. For example, but not by limitation, the mobile platform 2 may be a motor vehicle such as a van, bus, truck and/or car outfitted to present a mobile storefront to a potential customer 6.

The mobile retail platform 2 delivers the audio and audiovisual materials to a non-secular function 4. The non-secular function 4 can be any gathering formal or informal where persons of faith are gathered. For example, a non-secular function 4 may be worship service. The mobile retail platform 2 may arrive, before, during and/or after the worship service 4 to provide the participants the opportunity to rent various audio and audiovisual materials in a convenient setting.

The customer 6 is typically one who is attending the non-secular function 4 and is one who is apt to return to such function 4 on a regular basis. Thus, the mobile retail platform 2 may make scheduled stops at the non-secular function 4 to both pickup previously rented materials along with providing new material for rent.

The materials for rent may be both audio and audiovisual. The materials are preferably non-secular in nature and may be exclusively religious in their content. The materials may further be selected and directed to a particular religion. The audio material typically includes audio teaching CDs and cassette tapes. Such teaching materials may include sermons, presentations by various speakers and audio books. Additionally, audiovisual materials include videos in the form of DVDs or video cassettes of religious movies, presentations, and/or speakers.

The materials for rent may be lent for a set fee and for a set period of time. The fees and time periods may vary depending upon the materials lent. Additionally, the present method may include memberships, various offers, discounts and merchandise that may be for sale or rent.

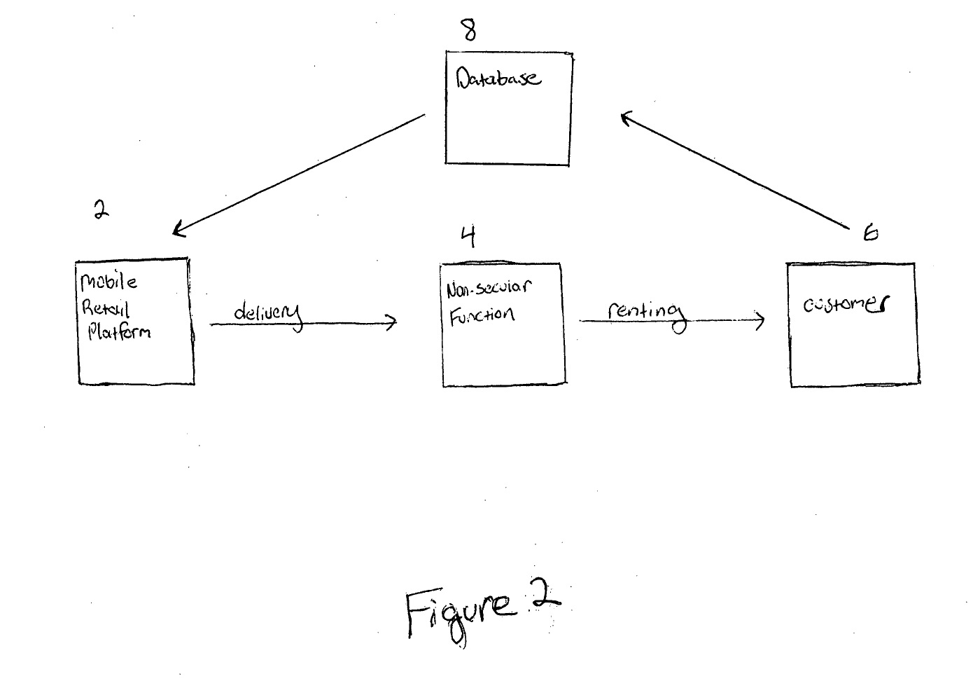

FIG. 2 illustrates the embodiment of the present method including a customer's 6 preferences and renting habits stored and recorded in a database 8. Additional information may also be recorded in the database 8 such as the customer's 6 credit and account information. The database 8 may be used to suggest further titles to the customer 6 for renting. The database 8 may also be used for marketing.

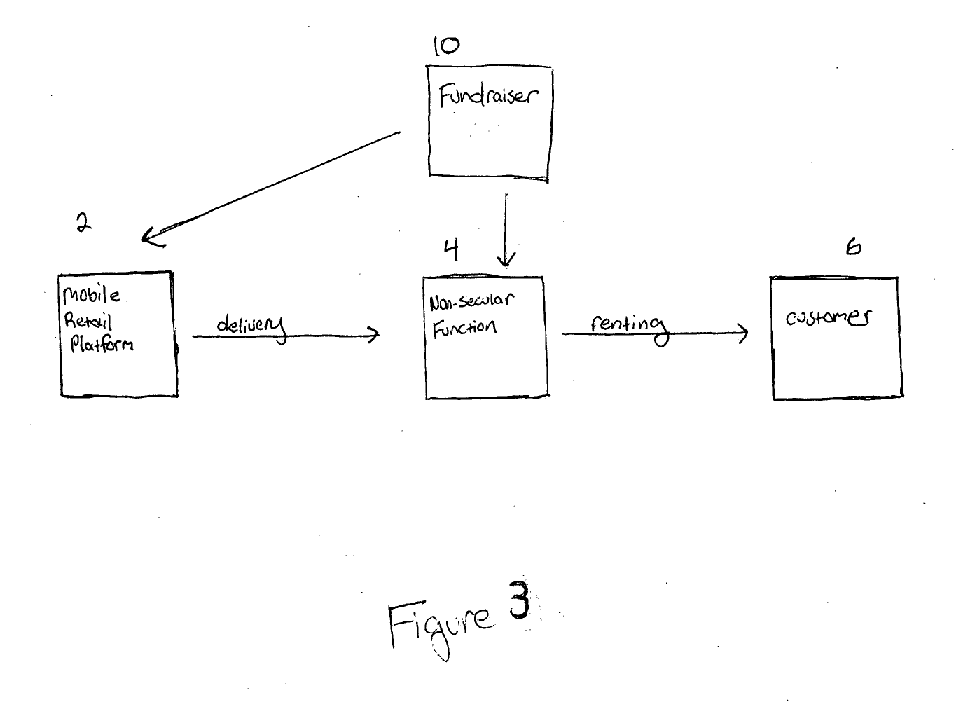

FIG. 3 depicts a further embodiment of the present for providing a mobile, non-secular media delivery service. The method depicted in FIG. 3 illustrates a possible fundraising aspect of the present method. Funds 10 raised by the renting of the materials may be split between the operator of the mobile retail platform 2 and a non-secular group. For example, but not by limitation, the method may include a fee paid to organizers of the religious event, wherein the fee is part of a fund raising activity for the organizers of the religious event and is based in part on funds 10 collected from the rental of the materials. The fundraising embodiment can be both a promotional opportunity for the operator of the mobile retail platform 2 and the organizers of a non-secular event 4 or to a group or individual to which the funds are to be designated.

While Applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A method of providing mobile non-secular audio and audiovisual media materials comprising:
providing a mobile retail platform including various non-secular audio and audiovisual media materials contained therein;
delivering the mobile retail platform to various non-secular functions; and
renting the audio and audiovisual media materials to customers.

2. The method of claim 1, further including a tracking database for cataloging a selected customer's preferences.

3. The method of claim 2, further including providing suggestions to the selected customer based on the collected preferences.

4. The method of claim 1, wherein the retail platform is selected from the group consisting of an automobile, truck, van, bus or combinations thereof.

5. The method of claim 1, wherein the non-secular functions include religious services.

6. The method of claim 1, wherein the audio and audiovisual materials include sermons given by various religious teachers.

7. The method of claim 1, wherein the audio and audiovisual materials are rented for a predetermined period of time.

8. The method of claim 7, further including a fee being assessed for all materials held beyond the set period of time.

9. The method of claim 1, wherein the mobile platform follows a predetermined route which includes return trips for picking up rented materials.

10. The method of claim 1, wherein the non-secular audio and audiovisual materials are directed to a singular religion.

11. A method of providing mobile non-secular teaching materials to participants at a religious function comprising:
providing a mobile retail platform including a collection of audio and audiovisual teaching materials exclusively of a non-secular nature;
delivering the mobile retail platform to a religious event having various attendees; and
renting the audio and audiovisual materials to the various attendees for a fee for a fixed period of time.

12. The method of claim 11, wherein the religious event is a church service.

13. The method of claim 11, further including a fee paid to organizers of the religious event.

14. The method of claim 13, wherein the fee is a fund raising activity for the
organizers of the religious event and is based in part on fees collected from the rental of the materials.

15. The method of claim 13, wherein exclusivity is granted in exchange for the fee.

16. The method of claim 11, further including franchising the method.

17. A method of providing mobile non-secular teaching materials to participants at a religious function comprising:
providing a mobile retail platform comprising a motor vehicle including a collection of audio and audiovisual teaching materials exclusively of a non-secular nature for a religious audience;
delivering the mobile retail platform to a church service having various attendees; and renting the audio and audiovisual materials to the various attendees for a fee for a fixed period of time.

18. The method of claim 17, wherein the audio material is selected from the group consisting of audio cassette tape, audio CD and combinations thereof.

19. The method of claim 17, wherein the audiovisual material may be selected from the group consisting of DVDs, video cassettes and combinations thereof.

20. The method of claim 17, further including a fee paid to organizers of the religious event, wherein the fee is part of a fund raising activity for the organizers of the religious event and is based in part on fees collected from the rental of the materials.
